(19) United States
(12) Patent Application Publication
(10) Pub. No.: US 2015/0079989 A1
(43) Pub. Date: Mar. 19, 2015

(54) APPARATUS AND METHODS OF CELL RESELECTION WHEN CAMPING ON A SMALL COVERAGE CELL

(71) Applicant: QUALCOMM Incorporated, San Diego, CA (US)

(72) Inventors: Sundaresan TAMBARAM KAILASAM, San Diego, CA (US); Uzma Khan, San Marcos, CA (US); Su Yi, San Jose, CA (US)

(73) Assignee: QUALCOMM Incorporated, San Diego, CA (US)

(21) Appl. No.: 14/219,994

(22) Filed: Mar. 19, 2014

Related U.S. Application Data
(60) Provisional application No. 61/879,606, filed on Sep. 18, 2013.

(51) Int. Cl. H04W 36/30

(52) U.S. Cl. CPC H04W 36/30
USPC 455/436

(57) ABSTRACT

Methods and apparatus are described for cell reselection when camping on a small cell. The methods and apparatus include determining, by a user equipment (UE), whether to perform a cell reselection evaluation after camping on a small cell communicating with the UE; performing a measurement of a signal transmitted by the small cell in response to determining whether to perform the cell reselection evaluation; determining that a signal characteristic based on the measurement of the signal of the small cell falls below a cell reselection measurement triggering threshold; performing a measurement of a respective signal transmitted by one or more other cells in only a serving frequency; ranking the small cell relative to the one or more other cells; and remaining camped on the small cell when the small cell is ranked higher than the one or more other cells.

### CLAIM OF PRIORITY UNDER 35 U.S.C. §119

The present application for Patent claims priority to U.S. Provisional Application No. 61/879,606 entitled “APPARATUS AND METHOD OF CELL RESELECTION WHEN CAMPING ON A SMALL COVERAGE CELL” filed Sep. 18, 2013, and assigned to the assignee hereof and hereby expressly incorporated by reference.

### BACKGROUND

The present disclosure relates to wireless communication, and more specifically, to aspects of search and measurement scheduling in a cell reselection procedure executed a user equipment (UE) when camping on a small cell.

Wireless communication networks are widely deployed to provide various communication services such as telephony, video, data, messaging, broadcasts, and so on. Such networks, which are usually multiple access networks, support communications for multiple UEs by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), Time Division-Synchronous Code Division Multiple Access (TD-SCDMA), High Speed Packet Access (HSPA), and Long Term Evolution (LTE), which uses orthogonal frequency division multiple access (OFDMA) on the downlink (DL), single-carrier frequency division multiple access (SC-FDMA) on the uplink (UL), and multiple-input multiple-output (MIMO) antenna technology.

Further, to supplement conventional wireless network base stations, referred to as macro base stations or macro cells, a network operator may deploy or allow users to deploy additional base stations to provide more robust wireless coverage to UEs. For example, wireless relay stations and small-coverage or closed subscriber group (CSG) base stations or cells (commonly referred to as access point base stations, Home NodeBs, femto access points, femto cells, or pico cells) may be deployed for incremental capacity growth, richer user experience, and in-building coverage. Typically, such small-coverage base stations are connected to the Internet and the network of the mobile network operator via a digital subscriber line (DSL) router or cable modem.

Additionally, in UMTS, the user equipment (UE) shall regularly search for a better cell to camp on according to the cell reselection criterion provided by the network, for example, as defined by 3GPP Technical Specification TS 25.304, “User Equipment (UE) procedures in idle mode and procedures for cells reselection in connected mode,” hereby incorporated by reference herein. This mechanism is used to ensure an acceptable quality of the camping cell, and therefore to achieve a desired call setup performance. A very reactive cell reselection mechanism can guarantee an adequate quality of the camping cell, however, this gain is achieved at the expense of stand-by time, which is decreased by frequent reselections.

Moreover, while the standards define the cell reselection criteria and some rules for performing a cell reselection evaluation when camping on the small coverage base station, the implementation of small coverage cell search and measurement scheduling in a cell reselection procedure may include many searches and measurements that adversely affect UE standby time and user experience.

Thus, improvements in performing a cell reselection evaluation when camping on the small coverage base station are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, methods and apparatus for cell reselection when camped on a small cell comprises determining, by a user equipment (UE), whether to perform a cell reselection evaluation after camping on the small cell communicating with the UE in a serving frequency and according to a serving radio access technology (RAT). Further, the methods and apparatus include performing a measurement of a signal transmitted by the small cell in response to determining whether the cell reselection evaluation should be performed. Moreover, the methods and apparatus include determining that a signal characteristic based on the measurement of the signal of the small cell falls below a cell reselection measurement triggering threshold. Additionally, the methods and apparatus include performing a measurement of a respective signal transmitted by one or more other cells in only the serving frequency in response to the signal characteristic of the small cell falling below the measurement triggering threshold. Further, the methods and apparatus include ranking the small cell relative to the one or more other cells based on the signal characteristic of the small cell and a respective signal characteristic of the one or more other cells determined from the measurement of the respective signal transmitted by the one or more other cells. Moreover, the methods and apparatus include remaining camped on the small cell when the small cell is ranked higher than the one or more other cells.

Further aspects provide a computer program product for cell reselection when camped on a small cell comprising a computer-readable medium includes at least one instruction for determining, by a user equipment (UE), whether to perform a cell reselection evaluation after camping on the small cell communicating with the UE in a serving frequency and according to a serving radio access technology (RAT). Further, the computer program product further comprises at least one instruction for performing a measurement of a signal transmitted by the small cell in response to determining whether the cell reselection evaluation should be performed. Moreover, the computer program product further comprises at least one instruction for determining that a signal characteristic based on the measurement of the signal of the small cell falls below a cell reselection measurement triggering threshold. Additionally, the computer program product further comprises at least one instruction for performing a measurement of a respective signal transmitted by one or more other cells in only the serving frequency in response to the signal characteristic of the small cell falling below the measurement triggering threshold. Further, the computer program product further comprises at least one instruction for ranking the small cell relative to the one or more other cells based on the signal characteristic of the small cell and a respective signal characteristic of the one or more other cells determined from the measurement of the respective signal transmitted by the one or more other cells. Moreover, the computer program product further comprises at least one instruction for remaining camped on the small cell when the small cell is ranked higher than the one or more other cells.

Additional aspects provide an apparatus for communication comprises means for determining whether to perform a cell reselection evaluation after camping on the small cell communicating with the UE in a serving frequency and according to a serving radio access technology (RAT). The apparatus further comprises means for performing a measurement of a signal transmitted by the small cell in response to determining whether the cell reselection evaluation should be performed. Moreover, the apparatus comprises means for determining that a signal characteristic based on the measurement of the signal of the small cell falls below a cell reselection measurement triggering threshold. Additionally, the apparatus comprises means for performing a measurement of a respective signal transmitted by one or more other cells in only the serving frequency in response to the signal characteristic of the small cell falling below the measurement triggering threshold. Further, the apparatus comprises means for ranking the small cell relative to the one or more other cells based on the signal characteristic of the small cell and a respective signal characteristic of the one or more other cells determined from the measurement of the respective signal transmitted by the one or more other cells. Moreover, the apparatus comprises means for remaining camped on the small cell when the small cell is ranked higher than the one or more other cells.

In an additional aspect, an apparatus for communication comprises a memory storing executable instructions and a processor in communication with the memory, wherein the processor is configured to execute the instructions to determine, by a user equipment (UE), whether to perform a cell reselection evaluation after camping on the small cell communicating with the UE in a serving frequency and according to a serving radio access technology (RAT). The processor is further configured to perform a measurement of a signal transmitted by the small cell in response to determining whether the cell reselection evaluation should be performed. Moreover, the methods and apparatus include determining that a signal characteristic based on the measurement of the signal of the small cell falls below a cell reselection measurement triggering threshold. Additionally, the processor is configured to perform a measurement of a respective signal transmitted by one or more other cells in only the serving frequency in response to the signal characteristic of the small cell falling below the measurement triggering threshold. Further, the processor is configured to rank the small cell relative to the one or more other cells based on the signal characteristic of the small cell and a respective signal characteristic of the one or more other cells determined from the measurement of the respective signal transmitted by the one or more other cells. Moreover, the processor is configured to remain camped on the small cell when the small cell is ranked higher than the one or more other cells.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an aspect of a system including a UE having a communication manager component as described herein;

FIG. 2 is a schematic diagram of an aspect of the communication manager component of FIG. 1;

FIG. 3 is a flowchart of an aspect of a method that may be executed by the UE and/or communication manager component of FIG. 1;

FIG. 4 is a flowchart of an aspect of a method that may be executed by the UE and/or communication manager component of FIG. 1;

FIG. 5 is a schematic diagram of an example hardware implementation for an apparatus employing a processing system configured to perform the functions described herein;

FIG. 6 is a schematic diagram conceptually illustrating an example of a telecommunications system in which a UE configured according to the present aspects may operate;

FIG. 7 is a schematic diagram illustrating an example of an access network in which a UE configured according to the present aspects may operate;

FIG. 8 is a schematic diagram of an exemplary communication system including deployment of small coverage cells within a network environment;

FIG. 9 is a block diagram conceptually illustrating an example of a Node B in communication with a UE, configured as describe herein, in a telecommunications system; and

FIG. 10 illustrates a system for cell reselection when camped on a small cell in accordance with an aspect of the present disclosure, e.g., according to FIG. 1.

### DETAILED DESCRIPTION

Various aspects are now described with reference to the drawings. In the following description, for purposes of explanation, numerous specific details are set forth in order to provide a thorough understanding of one or more aspects. It may be understood, however, that the present aspects may be practiced without these specific details.

According to the present apparatus and methods, a user equipment (UE) that is camped on a small coverage cell and triggered to perform a cell reselection evaluation is configured to avoid making cell measurements, even when a quality of the small coverage cell is below a cell reselection measurement triggering threshold of one more networks, based on determining that the small coverage cell is the best ranked cell in a serving frequency of the small coverage cell. In other words, although the quality of the small coverage cell is below one or more cell reselection measurement triggering thresholds, the UE will not perform certain measurements and searches, or reselect to a cell, when the small coverage cell is the best ranked cell on its serving frequency. Thus, even in the presence of strong cell candidates for reselection, e.g., cells having high received signal strengths at the UE, the present apparatus and methods may enable the UE to remain camped on the small coverage cell, and may enable avoiding unnecessary cell measurements and searches.

As a result, the present apparatus and methods may enable the UE to save power and processing resources, and thereby improve standby time and improve the user experience.

The term “small cell” (or “small coverage cell”), as used herein, may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a base station (BS), an access point, a femto node, a femtocell, a pico node, a micro node, a Node B, evolved Node B (eNB), home Node B (HNB) or home evolved Node B (HeNB). Therefore, the term “small cell,” as used herein, refers to a relatively low transmit power and/or a relatively small coverage area cell as compared to a macro cell.

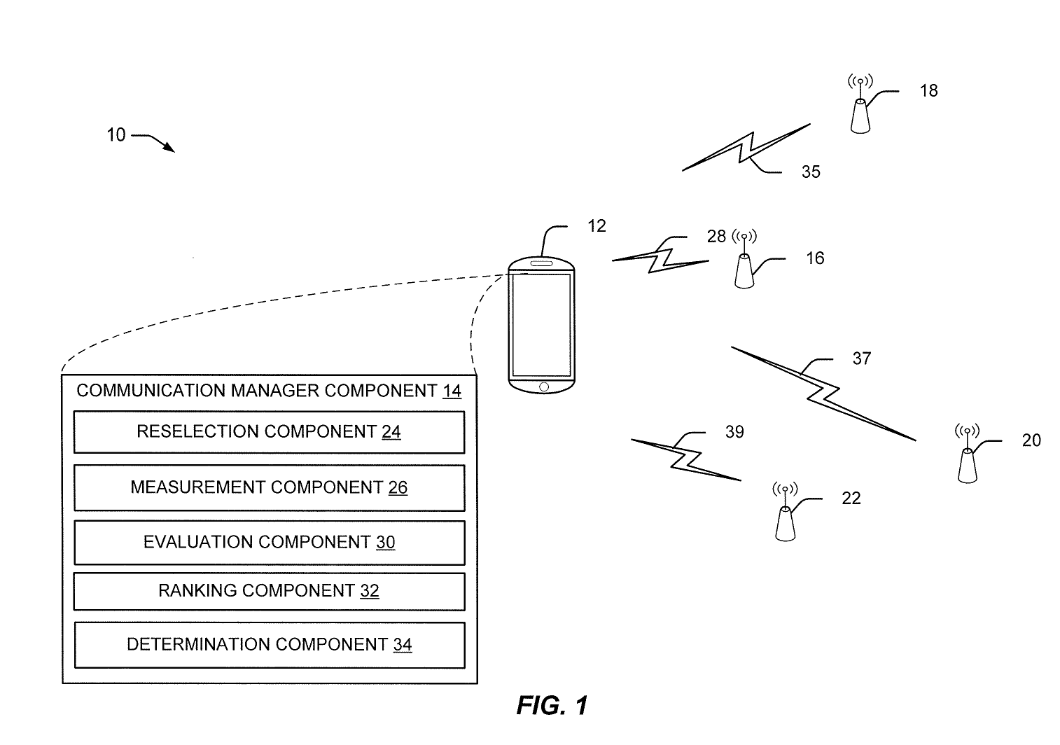

FIG. 1 is a block diagram conceptually illustrating an example of a wireless communication system 10 in accordance with an aspect of the present disclosure. Wireless network system 10 may include one or more cells, for example, one or more evolved NodeBs (eNodeBs) and/or network entities. For example, the one or more cells may include, small cell 16, intra-frequency cell 18, an inter-frequency cell 20, and/or an inter-RAT cell 22. In these aspects, small coverage cell 16, intra-frequency cell 18, inter-frequency cell 20, and inter-RAT cell 22, each may operate according to any radio access technology (RAT) standard, which may be the same RAT standard or different RAT standards for each of the respective cells. For instance, in one use case that should not be construed as limiting, small coverage cell 16 may be operating according to one of WCDMA, and each of intra-frequency cell 18, inter-frequency cell 20, and inter-RAT cell 22 may be operating according to one of WCDMA, GSM, LTE, and variants thereof.

In some aspects, the one or more cells in the telecommunications network system 100 may communicate according to at least one technology such as, but not limited to, long term evolution (LTE), universal mobile telecommunications system (UMTS), code division multiple access (CDMA) 2000, wireless local area network (WLAN) (e.g., WiFi). Further, the transmission-related parameters associated with each of the one or more network entities, such as the foregoing non-limiting example network entities may include, but are not limited to, physical cell identity (PCI), primary synchronization code (PSC), pseudo-random noise code (PN), channel numbers and/or beacon patterns.

Moreover, for example, the wireless network system 10 may be an LTE network or some other wide wireless area network (WWAN). As such, the wireless communication system 10 may include a UE 12 having a communication manager component 14 configured to efficiently perform cell reselection evaluations when UE 12 is camped on a small cell 16.

In certain aspects, communication manager component 14 may include reselection component 24, which may be configured to determine whether to perform a cell reselection evaluation after camping on a small cell (e.g., small cell 16) communicating with UE 12 in a serving frequency and according to a serving RAT. The communication manager component 14 may further include measurement component 26, which may be configured to perform a measurement of a signal (e.g., signal 28) transmitted by the small cell (e.g., small cell 16) in response to determining whether to perform the cell reselection evaluation. Moreover, communication manager component 14 may include evaluation component 30 which may be configured to determine that a signal characteristic based on the measurement of the signal (e.g., signal 28) of the small cell (e.g., small cell 16) falls below a cell reselection measurement triggering threshold. Additionally, measurement component 26 may be configured to perform a measurement of a respective signal (e.g., signals 35, 37, and/or 39) transmitted by one or more other cells (e.g., cells 18, 20, and/or 22) in only the serving frequency in response to the signal characteristic of the small cell (e.g., small cell 16) falling below the measurement triggering threshold. Further, communication manager component 14 may include ranking component 32 which may be configured to rank the small cell (e.g., small cell 16) relative to the one or more other cells (e.g., cells 18, 20, and/or 22) based on the signal characteristic of the small cell and a respective signal characteristic of the one or more other cells determined from the measurement of the respective signal (e.g., signals 35, 37, and/or 39) transmitted by the one or more other cells. Moreover, communication manager component 14 may include determination component 34 which may be configured to remain camped on the small cell (e.g., small cell 16) when the small cell is ranked higher than the one or more other cells (e.g., cells 18, 20, and/or 22).

An eNodeB may be an example of a station that communicates with one or more UEs (e.g., UE 12) and may also be referred to as a base station, an access point, etc. Each eNodeB (e.g., cells 16, 18, 20, and/or 22) may provide communication coverage for a particular geographic area. In 3GPP, the term “cell” can refer to a coverage area of an eNodeB 110 and/or an eNodeB subsystem serving the coverage area, depending on the context in which the term is used.

An eNodeB may provide communication coverage for a macro cell, a pico cell, a femto cell, and/or other types of cell. A macro cell may cover a relatively large geographic area (e.g., several kilometers in radius) and may allow unrestricted access by one or more UEs (e.g., UE 12) with service subscription. A pico cell may cover a relatively small geographic area and may allow unrestricted access by one or more UEs (e.g., UE 12) with service subscription. A femto cell may cover a relatively small geographic area (e.g., a home) and may allow restricted access by one or more UEs (e.g., UE 12) having association with the femto cell (e.g., UE 12 may be subscribed to a Closed Subscriber Group (CSG), UE 12 for users in the home, etc.).

An eNodeB for a macro cell may be referred to as a macro eNodeB. An eNodeB for a pico cell may be referred to as a pico eNodeB. An eNodeB for a femto cell may be referred to as a femto eNodeB or a home eNodeB. In the example shown in FIG. 1, the eNodeBs may be macro eNodeBs for the macro cells 18, 20, and 22. An eNodeB may provide communication coverage for one or more (e.g., three) cells.

The wireless network system 10 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network system 10. For example, macro eNodeBs (e.g., cells 18, 20, and/or 22) may have a high transmit power level (e.g., 20 Watts) whereas pico eNodeBs, femto eNodeBs (e.g., small cell 16) and relays may have a lower transmit power level (e.g., 1 Watt).

The wireless network system 10 may support synchronous or asynchronous operation. For synchronous operation, the eNodeBs may have similar frame timing, and transmissions from different eNodeBs and may be approximately aligned in time. For asynchronous operation, the eNodeBs may have different frame timing, and transmissions from different eNodeBs and may not be aligned in time. The techniques described herein may be used for both synchronous and asynchronous operation.

The one or more UEs (e.g., UE 12) may be dispersed throughout the wireless network system 10, and each UE may be stationary or mobile. For example, the UE 12 may be referred to as a terminal, a mobile station, a subscriber unit, a station, etc. In another example, the UE 12 may be a cellular phone, a Smartphone, a personal digital assistant (PDA), a wireless modem, a wireless communication device, a handheld device, a laptop computer, a cordless phone, a wireless local loop (WLL) station, a tablet, a netbook, a smart book, etc. The UE 12 may be able to communicate with macro eNodeBs, pico eNodeBs, femto eNodeBs, relays, etc.

LTE may utilize orthogonal frequency division multiplexing (OFDM) on the downlink and single-carrier frequency division multiplexing (SC-FDM) on the uplink. OFDM and SC-FDM may partition the system bandwidth into multiple (K) orthogonal subcarriers, which are also commonly referred to as tones, bins, etc. Each subcarrier may be modulated with data. In general, modulation symbols may be sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal Fast Fourier Transform (FFT) size may be equal to 128, 256, 512, 1024 or 2048 for system bandwidth of 1.25, 2.5, 5, 10 or 20 megahertz (MHz), respectively. The system bandwidth may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

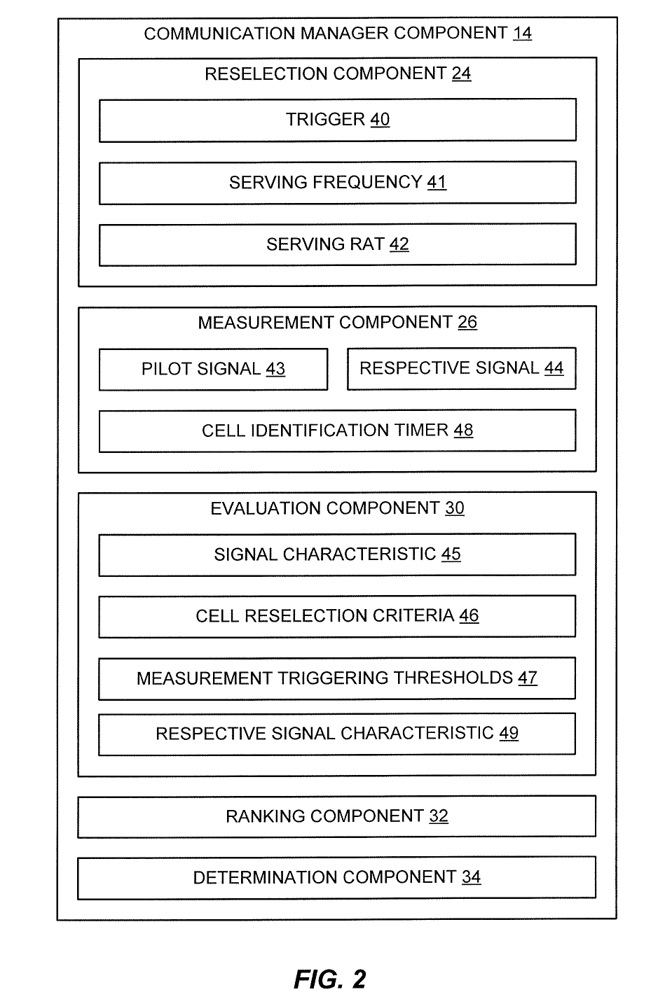

Referring to FIG. 2, an aspect of the communication manager component 14 may include various components and/or subcomponents, which may be configured to facilitate small cell reselection when UE 12 is camping on small cell 16. For instance, communication manager component 14 is configured to avoid making cell searches and measurements, and/or to avoid reselecting to another cell, such as one of an intra-frequency cell 18, an inter-frequency cell 20, and/or an inter-RAT cell 22, when small coverage cell 16 is the best ranked cell in a serving frequency of small coverage cell 16. The various components/subcomponents described herein enable communication manager component 14 to achieve such improved small cell reselection.

In an aspect, communication manager component 14 may include reselection component 24. For instance, reselection component 24 may be configured to determine whether to perform a cell reselection evaluation after camping on small cell 16 (FIG. 1) communicating with the UE 12 in a serving frequency 41 and according to a serving radio access technology (RAT) 42. For example, in an aspect, UE 12 and/or communication manager component 14 may execute a reselection component 24 that is configured to identify a trigger 40 for executing a cell reselection evaluation procedure. For instance, reselection component 24 may identify a trigger 40 such as, but not limited to, an occurrence of a discontinuous reception (DRX) time period, e.g., according to a DRX cycle, an occurrence or detection of network-indicated criteria such as may be received in a system information block (SIB) message, an occurrence of a change to information on the Broadcast Control Channel (BCCH) used for the cell reselection evaluation procedure, or any other occasion that dictates performance of a cell reselection evaluation procedure.

Further, communication manager component 14 may include measurement component 26. For instance, measurement component 26 may be configured to perform a measurement of a signal (e.g., pilot signal 43) transmitted by small cell 16 (FIG. 1) in response to determining whether to perform the cell reselection evaluation. In some instances, pilot signal 43 may correspond to signal 28 (FIG. 1) received from small cell 16. Further, measurement component 26 may be configured to perform a measurement of a respective signal transmitted by one or more other cells in only the serving frequency 41 in response to the signal characteristic 45 of the small cell 16 falling below a measurement triggering threshold 47. In some instances, measurement component 26 may include a transceiver or a receiver and/or receive chain components, including hardware and software, for receiving, decoding, and analyzing a signal.

In a further aspect, communication manager component 14 may include evaluation component 30. In some instances, evaluation component 30 may be configured to determine whether small cell 16 (FIG. 1) is suitable based on cell reselection criteria 46 and based on the measurement of the pilot signal 43 transmitted by small cell 16. For example, evaluation component 30 may receive pilot signal 43 from measurement component 26, analyze pilot signal 43, and generate at least one signal characteristic 45 (e.g., Sx, where Sx is the cell quality value for frequency division-duplexing (FDD) cells and E-UTRA cells and/or cell selection receive level for time division-duplexing (TDD) cells) based at least in part on the measurement of pilot signal 43. Further, for example, in an aspect, UE 12 and/or communication manager component 14 may execute an evaluation component 30 that is configured to compare the at least one signal characteristic 45 of pilot signal 43 to one or more of a set of cell reselection criteria 46 to determine whether or not small coverage cell 28 is still a suitable cell for serving UE 12. For instance, the cell reselection criteria 46 may include quality and receive level parameters. In an aspect, for example but not limited hereto, the cell reselection criteria 46 may include:

Squat=Q_{qualmeas}−Qqualmin

Srxlev=Qᵣₓₗₑᵥₘₑₐₛ−Qrxlevmin−Pcompensation

where:

| | |
|---|---|
| Squal | Cell Selection quality value (dB) |
| | Applicable only for frequency division-duplexing |
| | (FDD) cells and E-UTRA cells. |
| Srxlev | Cell Selection receive (RX) level value (dB) |
| Q_{qualmeas} | Measured cell quality value. The quality of the received |
| | signal expressed in Common Pilot Channel (CPICH) |
| | Ec/N0 (dB) for FDD cells, and Reference Signal Receive |
| | Quality (RSRQ) for E-UTRA cells. CPICH Ec/N0 and |
| | RSRQ shall be averaged. |
| | Applicable only for FDD cells and E-UTRA cells. |
| Qᵣₓₗₑᵥₘₑₐₛ | Measured cell RX level value. This is received signal, |
| | CPICH RSCP for FDD cells (dBm), Primary Common |
| | control physical channel (P-CCPCH) received signal |
| | code power (RSCP) for TDD cells (dBm), an averaged |
| | received signal level for GSM cells (dBm) and an |
| | averaged Reference Signal Receive Power (RSRP) for |
| | E-UTRA cells (dBm). CPICH RSCP, P-CCPCH RSCP, |
| | the received signal level for GSM cells and the RSRP |
| | for E-UTRA cells shall be averaged. |
| Qqualmin | Minimum required quality level in the cell (dB). |
| | Applicable only for FDD cells and E-UTRA cells. |
| Qrxlevmin | Minimum required RX level in the cell (dBm) |
| Pcompensation | max(UE_TXPWR_MAX_RACH - P_MAX, 0) (dB) |

In an aspect, when small cell 16 (FIG. 1) does not meet cell reselection criteria 46, then the communication manager component 14 may enable UE 12 to execute legacy cell reselection evaluation procedures. Further, in an aspect, further execution of the present aspects may be based on small coverage cell 16 meeting cell reselection criteria 46, or in other words, being a suitable cell for continuing to serve UE 12.

Further, evaluation component 30 may be configured to determine that a signal character 45 based on the measurement of the pilot signal 43 of small cell 16 (FIG. 1) falls below a cell reselection measurement triggering threshold 47. For example, determining that the signal characteristic 45 of the small cell 16 (FIG. 1) falls below the cell reselection measurement triggering threshold 47 further comprises determining that the signal characteristic 45 of the small cell 16 falls below at least one of an intra-frequency cell reselection measurement triggering threshold, an inter-frequency cell reselection measurement triggering threshold, and an inter-RAT cell reselection measurement triggering threshold. For example, in an aspect, UE 12 and/or communication manager component 14 may execute evaluation component 30 that is configured to compare one or more signal characteristics 45, e.g., Sx (where Sx is Squal for FDD cells and/or Srxlev for TDD), of pilot signal 43 to one or more respective cell reselection measurement triggering thresholds 47 and determine whether the one or more respective cell reselection measurement triggering thresholds 47 are met. For instance, evaluation component 30 that is configured to determine whether Sx S_{intrasearch}, where S_{intrasearch} is an intra-frequency cell reselection measurement triggering threshold, or Sx<=S_{intersearch}, where S_{intersearch} is an inter-frequency cell reselection measurement triggering threshold, or Sx<=Ssearch_{RAT m}, where Ssearch_{RAT m} is an inter-RAT cell reselection measurement triggering threshold for given RAT, m. In an aspect, for example, evaluation component 30 may obtain the one or more respective cell reselection measurement triggering thresholds 47 from the wireless network system 10, such as in a SIB message.

When one or more respective cell reselection measurement triggering thresholds 47 are met, conventionally, measurements and searches are performed on intra-frequency cells and inter-frequency cells and inter-RAT cells. Based on the present aspects, however, UE 12 may be able to avoid performing at least a part of such measurements and/or searches.

For example, measurement component 26 may be configured to perform a measurement of a respective signal 44 transmitted by one or more other cells (e.g., cells 18, 20, and/or 22 in FIG. 1) in only the serving frequency 41 in response to the signal characteristic 45 of the small cell 16 being below the one or more measurement triggering thresholds 47. In an aspect, for example, the performing of the measurement of the respective signal 44 transmitted by the one or more other cells (e.g., cells 18, 20, and/or 22 in FIG. 1) in only the serving frequency 41 further comprises performing a measurement on cells that have been previously identified when a cell identification timer 48 has not expired and performing a fresh cell identification when the cell identification timer 48 has expired. For example, in an aspect, UE 12 and/or communication manager component 14 may execute measurement component 26, which is specially configured according to the present aspects to measure only the serving frequency 41 in response to the signal characteristic of the small cell 16 (FIG. 1) being below one or more cell reselection measurement triggering thresholds 47. In other words, before proceeding with all of the measurements, the present aspects first measure the serving frequency 41 to determine a relative quality of small cell 16 in an effort to avoid unnecessary measurements and/or searching.

In a further aspect, communication manager component 14 may include ranking component 32. For instance, ranking component 32 may be configured to rank the small cell 16 (FIG. 1) relative to the one or more other cells (e.g., cells 18, 20, and/or 22) based on the signal characteristic 45 of the small cell 16 and a respective signal characteristic 49 of the one or more other cells determined from the measurement of the respective signal 44 transmitted by the one or more other cells. For example, in an aspect, UE 12 and/or communication manager component 14 may execute a ranking component 32 that is configured to compare the measured signal characteristic 45 of pilot signal 43 with any other detected and measured signals (e.g., signals 35, 27, and/or 39 in FIG. 1) in the serving frequency 41 of small cell 16, and to rank or otherwise relatively order small coverage cell 16 relative to any other detected cells (e.g., cells 18, 20, and/or 22) based on detected and measured signals in order to facilitate identifying whether or not small cell 16 is the highest ranked cell in the serving frequency 41.

In another aspect, communication manager component 14 may include determination component 34. For instance, determination component 34 may be configured to remain camped on the small cell 16 (FIG. 1) when the small cell 16 is ranked higher than the one or more other cells (e.g., cells 18, 20, and/or 22). In an aspect, for example, remaining camped on the small cell 16 is further based on the small cell 16 being suitable. For example, in an aspect, UE 12 and/or communication manager component 14 may execute a determination component 34 that is configured to communicate with ranking component 32 and to identify whether or not small cell 16 is the highest ranked cell in the serving frequency 41. In the case where small cell 16 is the highest ranked cell in the serving frequency 41, then determination component 34 is configured to allow UE 12 to remain camped on small cell 16.

Furthermore, UE 12 and/or communication manager component 14 may execute determination component 34 to initiate a sleep mode of operation based on the determination that UE 12 can remain camped on small cell 16. For example, in an aspect, communication manager component 14 may execute determination component 34 to shut down use of communication resources, e.g., all or part of transceiver or receiver, for a remainder of the current DRX time period until a next wake-up time corresponding to the occurrence of a next DRX time period.

Moreover, in an aspect, UE 12 and/or communication manager component 14 may execute measurement component 26 to detect and measure respective intra-frequency signals 35, inter-frequency signals 37, and inter-RAT signals 39 (FIG. 1) and otherwise perform all of the cell measurements per conventional or legacy procedures, e.g., based on the expiration of list timers and/or full search timers, and/or based on known timings or already detected cells or cells identified in one or more messages received from the wireless network system 10, such as SIB messages, for each respective RAT.

Additionally, in an aspect, determination component 34 may be configured to perform a cell reselection based on the respective measurements of the respective intra-frequency cells, the respective inter-frequency cells, and the respective inter-RAT cells (e.g., cells 18, 20, 22, respectively, in FIG. 1). For example, in an aspect, UE 12 and/or communication manager component 14 may execute reselection determiner component 32 that is configured to make a cell reselection determination and perform a cell reselection per conventional or legacy procedures.

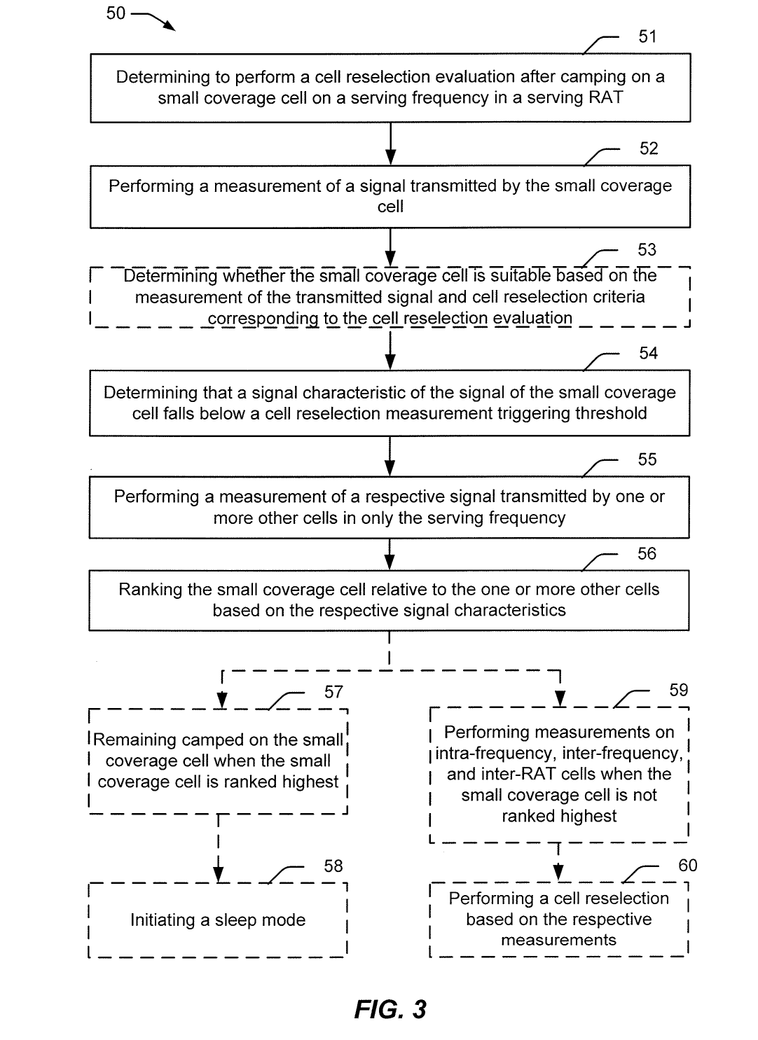

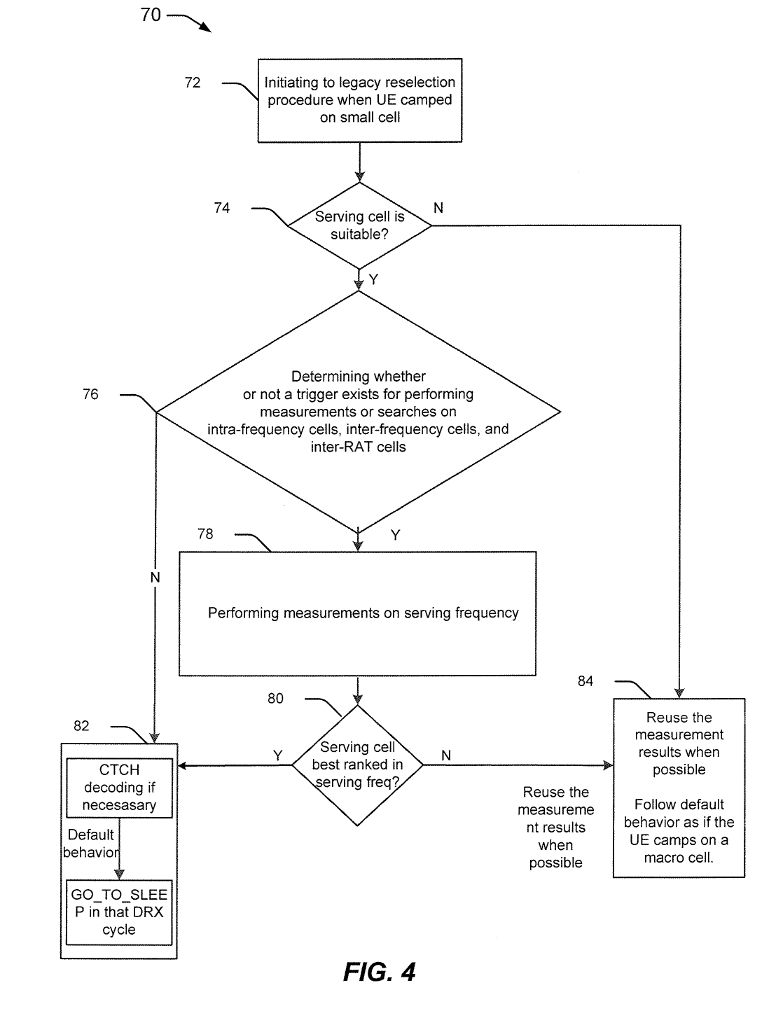

Referring to FIGS. 3 and 4, the methods are shown and described as a series of acts for purposes of simplicity of explanation. However, it is to be understood and appreciated that the methods (and further methods related thereto) are not limited by the order of acts, as some acts may, in accordance with one or more aspects, occur in different orders and/or concurrently with other acts from that shown and described herein. For example, it is to be appreciated that the methods may alternatively be represented as a series of interrelated states or events, such as in a state diagram. Moreover, not all illustrated acts may be required to implement a method in accordance with one or more features described herein.

Referring to FIG. 3, in an operational aspect, a UE such as UE 12 (FIG. 1) may perform one aspect of a method 50 for cell reselection when camping on a small coverage cell according to the communication manager component 14 (FIGS. 1 and 2). As described in further detail below, method 50 provides a process which may enhance cell reselection by a UE (e.g., UE 12, FIG. 1).

In an aspect, at block 51, method 50 includes determining, by a user equipment (UE), whether to perform a cell reselection evaluation after camping on a small cell communicating with the UE in a serving frequency and according to a serving radio access technology (RAT). For example, as described herein, communication manager component 14 (FIG. 2) may execute reselection component 24 to determine whether to perform a cell reselection evaluation after camping on small cell 16 (FIG. 1) communicating with the UE 12 in a serving frequency 41 and according to a serving radio access technology (RAT) 42. In some instances, reselection component 24 is configured to identify a trigger 40 for executing a cell reselection evaluation procedure.

At block 52, method 50 includes performing a measurement of a signal transmitted by the small cell in response to determining whether to perform the cell reselection evaluation. For example, as described herein, communication manager component 14 (FIG. 2) may execute measurement component 26 to perform a measurement of a signal (e.g., pilot signal 43) transmitted by small cell 16 (FIG. 1) in response to determining whether to perform the cell reselection evaluation. Further, in an aspect, UE 12 and/or communication manager component 14 may execute an evaluation component 30 that is configured to compare the at least one signal characteristic 45 of pilot signal 43 to one or more of a set of cell reselection criteria 46 to determine whether or not small coverage cell 28 is still a suitable cell for serving UE 12.

Further, at block 53, method 50 may optionally include determining whether the small coverage cell is suitable based on the measurement of the transmitted signal and the cell reselection criteria corresponding to the cell reselection evaluation. For example, as described herein, communication manager component 14 (FIG. 2) may execute evaluation component 26 to determine whether small cell 16 (FIG. 1) is suitable based on cell reselection criteria 46 and based on the measurement of the pilot signal 43 transmitted by small cell 16. For example, evaluation component 30 may receive pilot signal 43 from measurement component 26, analyze pilot signal 43, and generate at least one signal characteristic 45 based at least in part on the measurement of pilot signal 43.

At block 54, method 50 may include determining that a signal characteristic based on the measurement of the signal of the small cell falls below a cell reselection measurement triggering threshold. For example, as described herein, communication manager component 14 (FIG. 2) may execute evaluation component 30 to determine that a signal character 45 based on the measurement of the pilot signal 43 of small cell 16 (FIG. 1) falls below a cell reselection measurement triggering threshold 47.

At block 55, method 50 may include performing a measurement of a respective signal transmitted by one or more other cells in only the serving frequency in response to the signal characteristic of the small cell falling below the measurement triggering threshold. For example, as described herein, communication manager component 14 (FIG. 2) may execute measurement component 26 to perform a measurement of a respective signal 44 transmitted by one or more other cells (e.g., cells 18, 20, and/or 22 in FIG. 1) in only the serving frequency 41 in response to the signal characteristic 45 of the small cell 16 being below the one or more measurement triggering thresholds 47.

At block 56, method 50 may include ranking the small cell relative to the one or more other cells based on the signal characteristic of the small cell and a respective signal characteristic of the one or more other cells determined from the measurement of the respective signal transmitted by the one or more other cells. For example, as described herein, communication manager component 14 (FIG. 2) may execute ranking component 32 to rank the small cell 16 (FIG. 1) relative to the one or more other cells (e.g., cells 18, 20, and/or 22) based on the signal characteristic 45 of the small cell 16 and a respective signal characteristic 49 of the one or more other cells determined from the measurement of the respective signal 44 transmitted by the one or more other cells.

At block 57, method 50 may optionally include remaining camped on the small cell when the small cell is ranked higher than the one or more other cells. For example, as described herein, communication manager component 14 (FIG. 2) may execute determination component 34 to remain camped on the small cell 16 (FIG. 1) when the small cell 16 is ranked higher than the one or more other cells (e.g., cells 18, 20, and/or 22. For example, remaining camped on the small cell 16 is further based on the small cell 16 being suitable based cell reselection criteria 46. In an aspect, in an aspect, UE 12 and/or communication manager component 14 may execute a determination component 34 that is configured to communicate with ranking component 32 and to identify whether or not small cell 16 is the highest ranked cell in the serving frequency 41. In the case where small cell 16 is the highest ranked cell in the serving frequency 41, then determination component 34 is configured to allow UE 12 to remain camped on small cell 16.

At block 58, method 50 may optionally include initiating a sleep mode for the UE, wherein initiating the sleep mode comprises shutting down or otherwise reducing power consumed by one or more communication resources of the UE. For example, as described herein, communication manager component 14 (FIG. 2) may execute determination component 26 to initiate a sleep mode of operation based on the determination that UE 12 can remain camped on small cell 16. For example, in an aspect, communication manager component 14 may execute determination component 34 to shut down use of communication resources, e.g., all or part of transceiver or receiver, for a remainder of the current DRX time period until a next wake-up time corresponding to the occurrence of a next DRX time period.

At block 59, method 50 may optionally include performing measurements on any intra-frequency cells, any inter-frequency cells, and any inter-RAT cells listed in one or more received system information messages when the small cell is not ranked higher than the one or more other cells. For example, as described herein, communication manager component 14 (FIG. 2) may execute measurement component 26 to detect and measure respective intra-frequency signals 35, inter-frequency signals 37, and inter-RAT signals 39 (FIG. 1) and otherwise perform all of the cell measurements per conventional or legacy procedures, e.g., based on the expiration of list timers and/or full search timers, and/or based on known timings or already detected cells or cells identified in one or more messages received from the wireless network system 10, such as SIB messages, for each respective RAT.

At block 60, method 50 may optionally include performing a cell reselection based on the respective measurements of the respective intra-frequency cells, the respective inter-frequency cells, and the respective inter-RAT cells. For example, as described herein, communication manager component 14 (FIG. 2) may execute determination component 34 to perform a cell reselection based on the respective measurements of the respective intra-frequency cells, the respective inter-frequency cells, and the respective inter-RAT cells (e.g., cells 18, 20, 22, respectively, in FIG. 1).

Referring to FIG. 4, in one example of a particular use case that should not be construed as limiting, UE 12 and/or communication manager component 14 of FIG. 1 may execute a procedure 70 when UE 12 is camped on a small cell 16, such as a femto cell (block 72).

At block 74, method 70 may include UE 12 determining whether or not the small cell 16 is suitable. If not, then UE 12 performs conventional or legacy cell reselection procedures, as indicated at block 84. If small cell 16 is suitable, then at block 76 UE 12 determines whether or not a trigger exist for performing measurements or searches on intra-frequency cells, inter-frequency cells, and inter-RAT cells.

At block 76, method 70 may include determining whether or not a trigger exists for performing measurements or searches on intra-frequency cells, inter-frequency cells, and inter-RAT cells. For example, UE 12 (FIG. 1) and/or communication manager component 14 may be configured to determine whether Squal is less than Sintra and intra-frequency measurements on previously identified cells where the legacy conditions were satisfied. Alternatively, UE 12 (FIG. 1) and/or communication manager component 14 may be configured to determine whether Squal is less than Sintra and intra-frequency measurements on freshly identified cells where the legacy conditions were satisfied. Alternatively, UE 12 (FIG. 1) and/or communication manager component 14 may be configured to determine, when the legacy conditions are satisfied for intra-frequency, GSM, and/or LTE (IF/G/L), whether an IF/G/L measurement timer has expired; and whether NSET cells are detected. Alternatively, UE 12 (FIG. 1) and/or communication manager component 14 may be configured to determine, when the legacy conditions are satisfied for intra-frequency, GSM, and/or LTE (IF/G/L), whether IF/G/L fresh cell identification timer has expired and if IF/G/L frequencies are detected.

Additionally, for any measurements on previously identified cells and/or fresh cell identification (e.g., WCDMA/GSM/LTE) to happen then Squal is less than the respective threshold (e.g., WCDMA/GSM/LTE); the timer for measurements on previously identified cells and/or fresh cell identification on that respective RAT (W/G/L) should have expired; and measurements on previously identified cells and/or fresh cell identification need to have been performed. Specifically, for measurements on previously identified cells, there should be some timing known (e.g., whether a timer has expired) and/or already detected cells to measure on the respective RAT (W/G/L). Specifically, for fresh cell identification, there should be some cells broadcasted in SIBs to search on that respective RAT (W/G/L). If there is no trigger, then UE 12 proceeds to block 82 and optionally decodes CTCH, e.g., for emergency messages, or otherwise UE 12 returns to a sleep mode for the remainder of the current DRX cycle.

At block 76, if UE 12 does determine existence of a trigger, then UE 12 proceeds to block 78 and performs only measurements on the serving frequency. For example, UE 12 FIG. 1) and/or communication manager component 14 determines to whether to perform a measurement on previously identified cells or a fresh cell identification. In some instances, UE 12 and/or communication manager component 14 performs intra-frequency measurements and ranks all intra-frequency cells with the serving cell (e.g., small cell 16). As such, if the intra-frequency cell identification timer has not expired, then measurements are only performed on intra-frequency cells previously identified, if synchronized cells are present. Otherwise, fresh cell identification may be performed if the intra-frequency cell identification timer has expired and all the legacy conditions are satisfied.

Further, at block 80, based on the measurements in the serving frequency, UE 12 determines whether small coverage cell 16 is the highest ranked cell in the serving frequency If not, the UE 12 proceeds to block 84, where UE 12 performs the legacy cell reselection procedures. Alternatively, at block 80, if UE 12 determines that small coverage cell 16 is the highest ranked cell in the serving frequency, then UE 12 proceeds to block 82. As described above, at block 82 UE 12 optionally decodes CTCH, e.g., for emergency messages, or otherwise returns to a sleep mode for the remainder of the current DRX cycle.

Thus, based on configuration of UE 12 according to the present aspects, UE 12 may be able to skip or otherwise avoid some cell searches and measurements associated with conventional cell reselection procedures when UE 12 is camped on a suitable small coverage cell 16 and when small coverage cell 16 is the highest ranked cell in its serving frequency.

In particular, according to the apparatus and methods described above, UE 12 is skipping inter-frequency and inter-RAT (GSM/LTE) measurements as long as the camped CSG cell is best ranked in its frequency. Thus, according to the present aspects, UE 12 will go to sleep faster in every DRX cycle, thereby saving battery life.

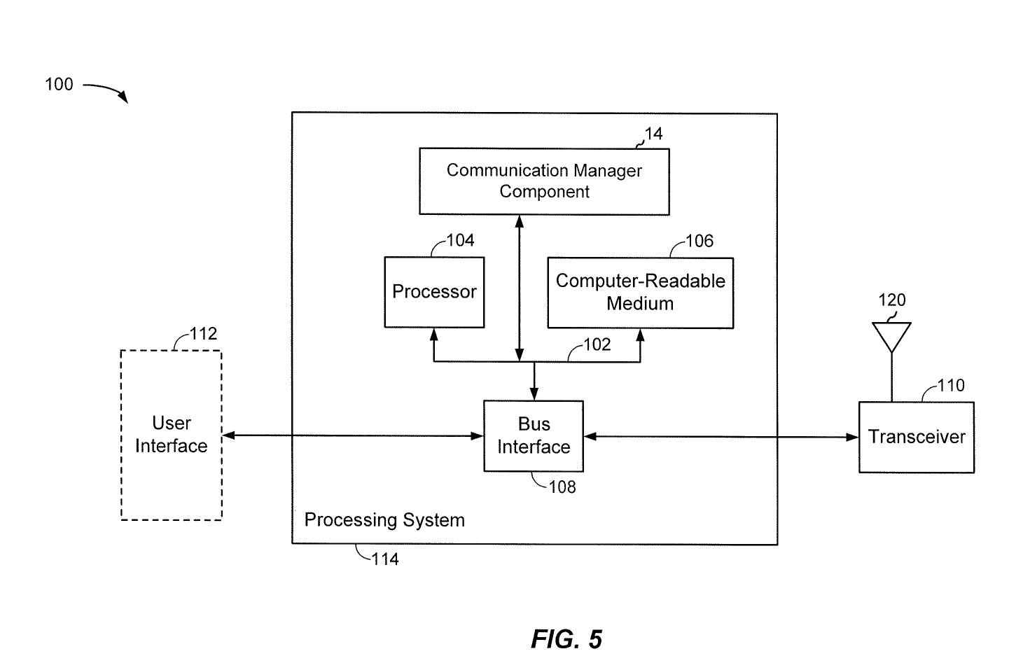

Referring to FIG. 5, one example of a hardware implementation of the present aspects includes an apparatus 100 employing a processing system 114 including communication manager component 14 (FIG. 1) as described above. For instance, apparatus 100 may be the same as or similar to, or may be included within, UE 12 of FIG. 1. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110, which is connected to one or more antennas 120 for receiving or transmitting signals. The transceiver 110 and one or more antennas provide a mechanism for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. Communication manager component 14 as described above may be implemented in whole or in part by processor 104, or by computer-readable medium 106, or by any combination of processor 104 and computer-readable medium 106.

The various concepts presented throughout this disclosure may be implemented across a broad variety of telecommunication systems, network architectures, and communication standards.

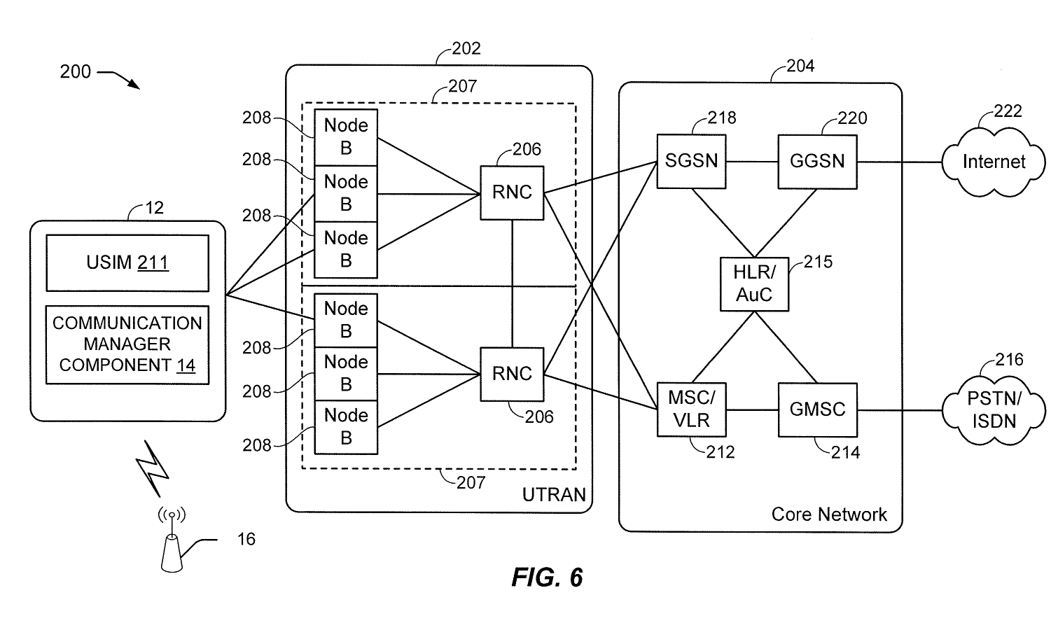

Referring to FIG. 6, by way of example and without limitation, the aspects of the present disclosure are presented with reference to a UMTS system 200 employing a W-CDMA air interface. In this case, user equipment 210 may be the same as or similar to UE 12 of FIG. 1, and may execute communication manager component 14 as described herein. UMTS system 200 includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

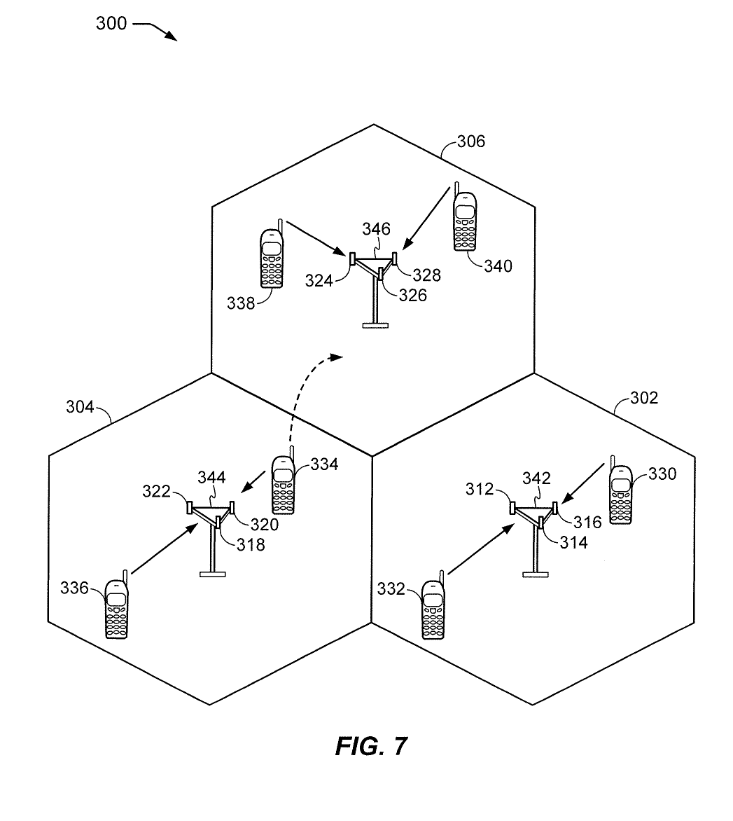

Referring to FIG. 7, in another example, an access network 300 in a UTRAN architecture is illustrated and may include one or more UEs configured like UE 12 of FIG. 1, e.g., to include communication manager component 14 as described herein. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206, or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

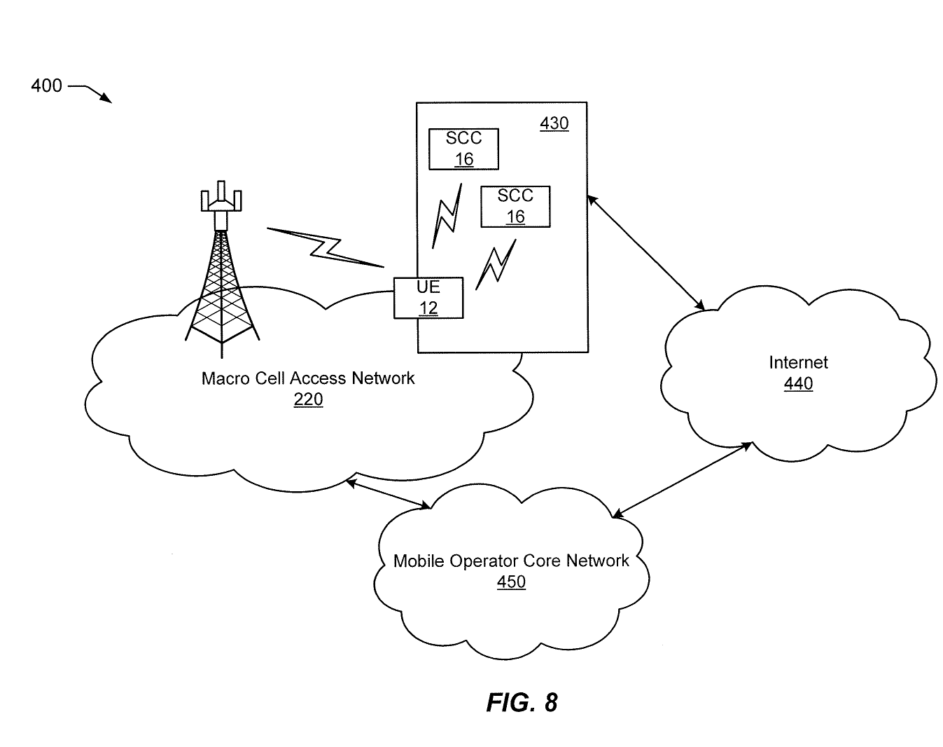

Referring to FIG. 8, in one aspect, UE 12 of FIG. 1 may operate in an exemplary communication system 400 that includes deployment of small coverage cells 16 within a network environment. The system 400 includes multiple small coverage cells 16 or femto cells, for example, each being installed in a corresponding small scale network environment, such as, for example, in one or more user residences 230. The small scale network environment, e.g., user residence 230, may be within or overlapping with one or more macro access networks 220 of one or more macro cells. As such, UE 12 may be able to communicate with either macro cell or small coverage cell 16. Further, each small coverage cell 16 may be being configured to serve associated, as well as alien, user equipment, such as UE 12. For instance, each small coverage cell 16 may be operate in an open mode, or in a closed mode where access is only granted to UEs that are members of a corresponding closed subscriber group (CSG), or in some combination of both mode, e.g., a hybrid mode. Each small coverage cell 16 is further coupled to the Internet 440 and a mobile operator core network 450, such as via a DSL router (not shown) or, alternatively, via a cable modem (not shown).

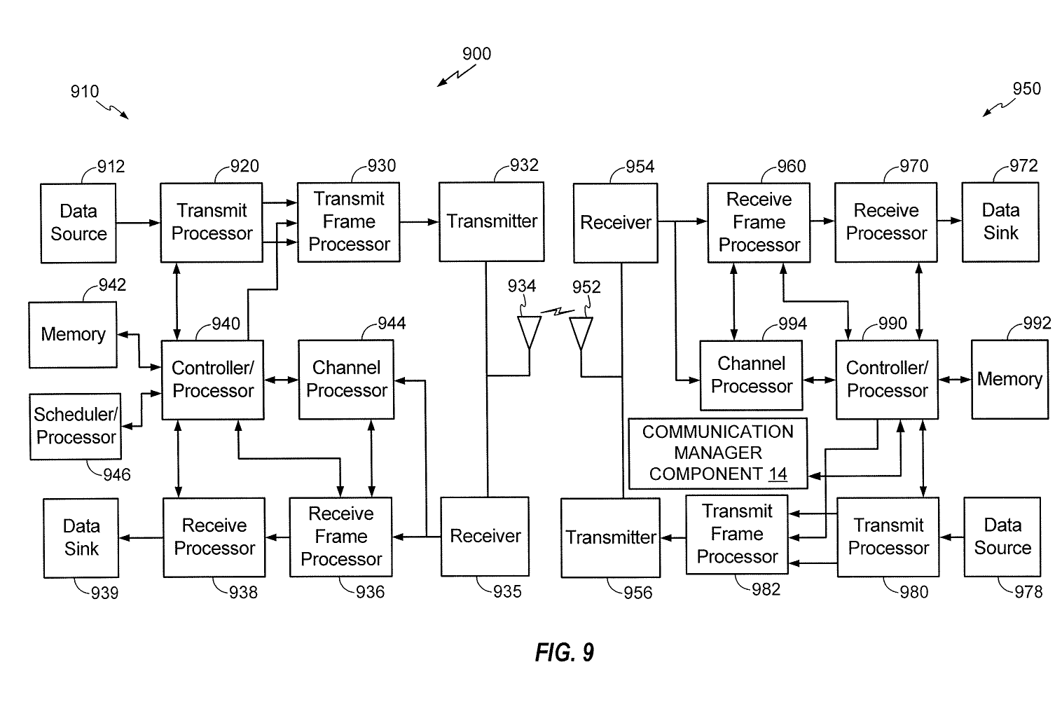

FIG. 9 is a block diagram of a Node B 910 in communication with a UE 950, where UE 950 may be UE 12 of FIG. 1 configured with communication manager component 14 as described herein. Moreover, Node B 910 may be any one of small coverage cell 16 or the other macro cells, e.g., cells 18, 20, and 22, of FIG. 1. In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 994 and the data, control, and reference signals to a receive processor 970. The receive processor 970 then performs the inverse of the processing performed by the transmit processor 920 in the Node B 910. More specifically, the receive processor 970 descrambles and despreads the symbols, and then determines the most likely signal constellation points transmitted by the Node B 910 based on the modulation scheme. These soft decisions may be based on channel estimates computed by the channel processor 994. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receiver processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

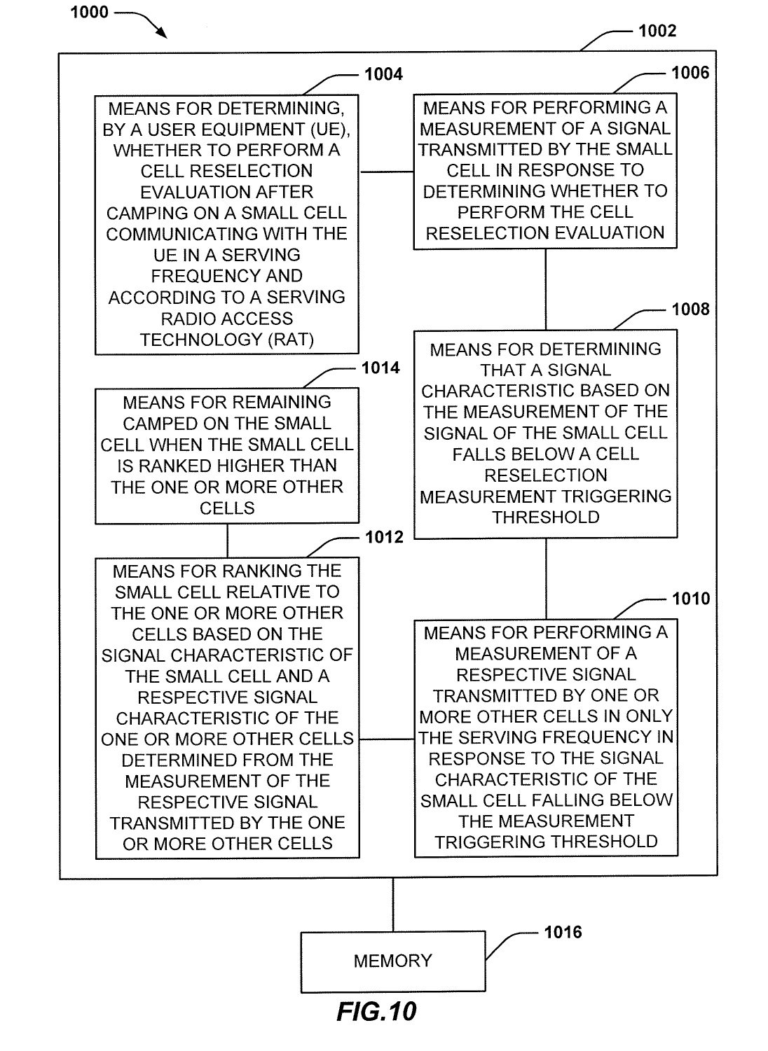

With reference to FIG. 10, illustrated is a system 1000 for facilitating small cell reselection when UE 12 is camping on small cell 16. For example, system 1000 can reside at least partially within a base station, mobile device, etc. It is to be appreciated that system 1000 is represented as including functional blocks, which can be functional blocks that represent functions implemented by a processor, software, or combination thereof (e.g., firmware). System 1000 includes a logical grouping 1002 of means that can act in conjunction. For instance, logical grouping 1002 can include means for determining, by a user equipment (UE), whether to perform a cell reselection evaluation after camping on a small cell communicating with the UE in a serving frequency and according to a serving radio access technology (RAT). Further, logical grouping 1002 can comprise means for performing a measurement of a signal transmitted by the small cell in response to determining whether to perform the cell reselection evaluation 1006. Moreover, logical grouping 1002 can comprise means for determining that a signal characteristic based on the measurement of the signal of the small cell falls below a cell reselection measurement triggering threshold 1008. Additionally, logical grouping 1002 can comprise means for performing a measurement of a respective signal transmitted by one or more other cells in only the serving frequency in response to the signal characteristic of the small cell falling below the measurement triggering threshold 1010. Logical grouping 1002 can comprise means for ranking the small cell relative to the one or more other cells based on the signal characteristic of the small cell and a respective signal characteristic of the one or more other cells determined from the measurement of the respective signal transmitted by the one or more other cells 1012. Logical grouping 1002 can comprise means for remaining camped on the small cell when the small cell is ranked higher than the one or more other cells 1014. Thus, as described, system 1000 facilitates small cell reselection when UE 12 is camping on small cell 16. Additionally, system 1000 can include a memory 1016 that retains instructions for executing functions associated with the means 1004, 1006, 1008, 1010, 1012, and 1014. While shown as being external to memory 1016, it is to be understood that one or more of the means 1004, 1006, 1008, 1010, 1012, and 1014 can exist within memory 1016.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a UE, which can be a wired terminal or a wireless terminal. A UE can also be called a system, device, subscriber unit, subscriber station, mobile station, mobile, mobile device, remote station, remote terminal, access terminal, user terminal, terminal, communication device, user agent, or user device. A UE may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with UE or wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of wireless communication, comprising:
determining, by a user equipment (UE), whether to perform a cell reselection evaluation after camping on a small cell communicating with the UE in a serving frequency and according to a serving radio access technology (RAT);
performing a measurement of a signal transmitted by the small cell in response to determining whether to perform the cell reselection evaluation;
determining that a signal characteristic based on the measurement of the signal of the small cell falls below a cell reselection measurement triggering threshold;
performing a measurement of a respective signal transmitted by one or more other cells in only the serving frequency in response to the signal characteristic of the small cell falling below the measurement triggering threshold;
ranking the small cell relative to the one or more other cells based on the signal characteristic of the small cell and a respective signal characteristic of the one or more other cells determined from the measurement of the respective signal transmitted by the one or more other cells; and
remaining camped on the small cell when the small cell is ranked higher than the one or more other cells.

2. The method of claim 1, further comprising:
determining whether the small cell is suitable based on cell reselection criteria and based on the measurement of the signal transmitted by the small cell; and
wherein the remaining camped on the small cell is further based on the small coverage cell being suitable.

3. The method of claim 2, wherein the cell reselection criteria comprises at least one or both of a cell selection quality value and a cell selection receive level value, wherein the cell selection quality value and the cell selection receive level value are determined based at least in part on one or more of a measured cell quality value, measured cell receive level value, minimum required quality level, minimum required receive level, maximum transmit power level, and maximum radio frequency (RF) output power level.

4. The method of claim 1, further comprising initiating a sleep mode for the UE, wherein initiating the sleep mode comprises reducing power consumed by one or more communication resources of the UE.

5. The method of claim 1, wherein determining whether to perform the cell reselection evaluation comprises identifying a trigger, wherein the trigger comprises at least one or more of an occurrence of a discontinuous reception (DRX) time period, an occurrence of a network indicated criteria received in a system information block (SIB), and an occurrence of a change of information on a Broadcast Control Channel (BCCH).

6. The method of claim 1, wherein the cell reselection measurement triggering threshold may be received via a system information block (SIB) from a network entity.

7. The method of claim 1, wherein the determining that the signal characteristic of the small cell falls below the cell reselection measurement triggering threshold further comprises determining that the signal characteristic of the small cell falls below at least one of an intra-frequency cell reselection measurement triggering threshold, an inter-frequency cell reselection measurement triggering threshold, and an inter-RAT cell reselection measurement triggering threshold.

8. The method of claim 1, wherein performing the measurement of the respective signal transmitted by the one or more other cells in only the serving frequency further comprises performing a measurement on previously identified cells when a cell identification timer has not expired and performing a fresh cell identification when the cell identification timer has expired.

9. The method of claim 1, further comprising performing measurements on any intra-frequency cells, any inter-frequency cells, and any inter-RAT cells listed in one or more received system information messages when the small cell is not ranked higher than the one or more other cells.

10. The method of claim 11, further comprising performing a cell reselection based on the respective measurements of the respective intra-frequency cells, the respective inter-frequency cells, and the respective inter-RAT cells.

11. A computer program product, comprising:
a computer-readable medium comprising code for:
at least one instruction executable to cause a computer to determine, by a user equipment (UE), whether to perform a cell reselection evaluation after camping on a small cell communicating with the UE in a serving frequency and according to a serving radio access technology (RAT);
at least one instruction executable to cause the computer to perform a measurement of a signal transmitted by the small cell in response to determining whether to perform the cell reselection evaluation;
at least one instruction executable to cause the computer to determine that a signal characteristic based on the measurement of the signal of the small cell falls below a cell reselection measurement triggering threshold;
at least one instruction executable to cause the computer to perform a measurement of a respective signal transmitted by one or more other cells in only the serving frequency in response to the signal characteristic of the small cell falling below the measurement triggering threshold;
at least one instruction executable to cause the computer to rank the small cell relative to the one or more other cells based on the signal characteristic of the small cell and a respective signal characteristic of the one or more other cells determined from the measurement of the respective signal transmitted by the one or more other cells; and
at least one instruction executable to cause the computer to remain camped on the small cell when the small cell is ranked higher than the one or more other cells.

12. An apparatus for communication, comprising:
a memory storing executable instructions; and
a processor in communication with the memory, wherein the processor is configured to execute the instructions to:
determine, by a user equipment (UE), whether to perform a cell reselection evaluation after camping on a small cell communicating with the UE in a serving frequency and according to a serving radio access technology (RAT);
perform a measurement of a signal transmitted by the small cell in response to determining whether to perform the cell reselection evaluation;
determine that a signal characteristic based on the measurement of the signal of the small cell falls below a cell reselection measurement triggering threshold;
perform a measurement of a respective signal transmitted by one or more other cells in only the serving frequency in response to the signal characteristic of the small cell falling below the measurement triggering threshold;
rank the small cell relative to the one or more other cells based on the signal characteristic of the small cell and a respective signal characteristic of the one or more other cells determined from the measurement of the respective signal transmitted by the one or more other cells; and
remain camped on the small cell when the small cell is ranked higher than the one or more other cells.

13. The apparatus of claim 12, wherein the processor is further configured to execute the instructions to:
determine whether the small cell is suitable based on cell reselection criteria and based on the measurement of the signal transmitted by the small cell; and
wherein the remaining camped on the small cell is further based on the small coverage cell being suitable.

14. The apparatus of claim 13, wherein the cell reselection criteria comprises at least one or both of a cell selection quality value and a cell selection receive level value, and wherein the cell selection quality value and the cell selection receive level value are determined based at least in part on one or more of a measured cell quality value, measured cell receive level value, minimum required quality level, minimum required receive level, maximum transmit power level, and maximum radio frequency (RF) output power level.

15. The apparatus of claim 12, wherein the processor is further configured to execute the instructions to initiate a sleep mode for the UE, wherein initiating the sleep mode comprises reducing power consumed by one or more communication resources of the UE.

16. The apparatus of claim 12, wherein determining whether to perform the cell reselection evaluation comprises identifying a trigger, and
wherein the trigger comprises at least one or more of an occurrence of a discontinuous reception (DRX) time period, an occurrence of a network indicated criteria received in a system information block (SIB), and an occurrence of a change of information on a Broadcast Control Channel (BCCH).

17. The apparatus of claim 12, wherein the cell reselection measurement triggering threshold may be received via a system information block (SIB) from a network entity.

18. The apparatus of claim 12, wherein the determining that the signal characteristic of the small cell falls below the cell reselection measurement triggering threshold further comprises determining that the signal characteristic of the small cell falls below at least one of an intra-frequency cell reselection measurement triggering threshold, an inter-frequency cell reselection measurement triggering threshold, and an inter-RAT cell reselection measurement triggering threshold.

19. The apparatus of claim 12, wherein performing the measurement of the respective signal transmitted by the one or more other cells in only the serving frequency further comprises performing a measurement on previously identified cells when a cell identification timer has not expired and performing a fresh cell identification when the cell identification timer has expired.

20. The apparatus of claim 12, wherein the processor is further configured to execute the instructions to perform measurements on any intra-frequency cells, any inter-frequency cells, and any inter-RAT cells listed in one or more received system information messages when the small cell is not ranked higher than the one or more other cells, and wherein the processor is further configured to execute the instructions to perform a cell reselection based on the respective measurements of the respective intra-frequency cells, the respective inter-frequency cells, and the respective inter-RAT cells.
